(19) United States
(12) Patent Application Publication
(10) Pub. No.: US 2011/0051475 A1
(43) Pub. Date: Mar. 3, 2011

(54) REGULATOR CIRCUITRY FOR REDUCING RIPPLE RESULTED FROM LINE VOLTAGE TRANSMITTING TO SECONDARY SIDE OF POWER TRANSFORMER

(75) Inventors: Chung-Min Chang, Jhubei (TW); Ching-Hui Yu, Jhubei (TW); Chih-Chen Chen, Jhubei (TW); Canny Cheng, Jhubei (TW)

(73) Assignee: Power Light Tech. Co., Ltd., Jhubei (TW)

(21) Appl. No.: 12/633,046

(22) Filed: Dec. 8, 2009

(30) Foreign Application Priority Data
Aug. 26, 2009 (TW) 098128589

(51) Int. Cl. H02J 1/02

(52) U.S. Cl. 363/39

(57) ABSTRACT

The present invention discloses a regular circuitry for reducing ripple resulting from a line voltage transmitting to a secondary side of a power transformer. The regular circuitry electrically connected in parallel with the power transformer includes a ripple sampling circuit, a proportional amplifier circuit, and a reversing amplifier circuit. The ripple sampling circuit selects a sampling ripple from the input port of the power transformer, which is electrically connected in series between a primary side rectification circuit and a secondary side rectification circuit. The proportional amplifier circuit receives the sampling ripple to generate an amplified sampling ripple. The amplified sampling ripple transmits to the reversing amplifier circuit so that a reversed sampling ripple is generated. Thus, the reversed sampling ripple can be input to the output port of the power transformer to superimpose on the signal output from the power transformer to reduce the ripple resulting from the line voltage.

### BACKGROUND OF THE INVENTION

1. Technical Field

The present invention relates to a regular circuitry for reducing ripple resulting from a line voltage transmitting to a secondary side of a power transformer. More particularly, the present invention relates to a regular circuitry applicable to a power supply device.

2. Description of Related Art

The electronic devices extensively used in our daily lives, such as TV sets, audio devices, computers and so on, usually need a direct current supply to operate their internal electronic components. Therefore, power transformers would be implemented for them to transfer the AC grid supply into direct currents with various voltages adaptive to drive those electronic devices.

FIG. 1 depicts a circuitry diagram of a conventional power transformer 10 as well as its primary side rectification circuit 11 and secondary side rectification circuit 12. As shown in FIG. 1, the primary side rectification circuit 11 is electrically connected with a primary side of the power transformer 10 while the secondary side rectification circuit 12 is electrically connected with a secondary side of the power transformer 10. The power transformer 10 includes a transforming unit 13 that steps up or down a line voltage. When the line voltage drops below a certain frequency (1 k Hz), a considerably high ripple voltage can be generated at the secondary side during the process where the fundamental signal of the line voltage is transmitted to the secondary side from the primary side by way of the transforming unit 13. At this time, ripple noise can interfere with the fundamental signal of the secondary side.

One known solution for the foregoing problem is to reduce the ripple voltage by increasing the value of the capacitance of a capacitor C03 electrically connected in parallel with a bridge rectifier. However, in practice, there is limitation to such capacitance increase, meaning that reduction of the ripple noise at the fundamental signal of the secondary side is limited. Consequently, the fundamental signal output from the power transformer 10 comes with ripple noise and in turn, adversely affects the power supply. Hence, it would be desired to figure out an approach that effectively reduces ripple noise at the secondary side.

### SUMMARY OF THE INVENTION

The present invention discloses a regular circuitry for reducing ripple resulted from a line voltage transmitting to a secondary side of a power transformer, wherein the regular circuitry reduces the ripple by generating a signal that is in phase to, and has its amplitude of vibration inverse to that of, the ripple generated by the power transformer.

To achieve the aforementioned effect, the present invention provides a regular circuitry for reducing ripple resulting from a line voltage transmitting to a secondary side of a power transformer, wherein the regular circuitry is electrically connected in parallel with the power transformer, and the power transformer is electrically connected in series between a primary side rectification circuit and a secondary side rectification circuit. The regular circuitry includes: a ripple sampling circuit having an input port electrically connected with an input port of the power transformer and an output port outputting a sampling ripple; a proportional amplifier circuit receiving and amplifying the sampling ripple to generate an amplified sampling ripple; and a reversing amplifier circuit receiving the amplified sampling ripple and inversely outputting the same to an input port of the secondary side rectification circuit so as to reduce the ripple output from the power transformer.

By implementing the present invention, at least the following progressive effects can be achieved:

1. By electrically connecting the regular circuitry in parallel with the power transformer, the ripple at the secondary side of the power transformer can be effectively reduced.

2. By generating the signal that is in phase to, and has its amplitude of vibration inverse to that of, the ripple generated by the power transformer, and using the signal to offset the ripple generated by the power transformer, the ripple can be effectively reduced.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a circuitry diagram of a conventional power transformer as well as its primary side rectification circuit and secondary side rectification circuit;

FIG. 2 is a circuitry diagram of a regular circuitry for reducing ripple resulted from a line voltage transmitting to a secondary side of a power transformer according to a first embodiment of the present invention;

FIG. 3A is a waveform of a signal input to a primary side of the power transformer of FIG. 2;

FIG. 3B is a waveform of a signal output by a secondary side of the power transformer of FIG. 2;

FIG. 4A is a waveform of the signal at a first node of FIG. 2;

FIG. 4B is a waveform of the signal at a second node of FIG. 2;

FIG. 4C is a waveform of the signal at a third node of FIG. 2;

FIG. 5A is a waveform of a signal output by the reversing amplifier circuit of FIG. 2;

FIG. 5B is a waveform of a signal input to the secondary side rectification circuit of FIG. 2;

FIG. 6 is a circuitry diagram of a regular circuitry for reducing ripple resulted from a line voltage transmitting to a secondary side of a power transformer according to a second embodiment of the present invention;

FIG. 7 is a waveform of the signal at a fourth node of FIG. 6;

FIG. 8A is a waveform of a signal output by the reversing amplifier circuit of FIG. 6; and

FIG. 8B is a waveform of a signal input to the secondary side rectification circuit of FIG. 6.

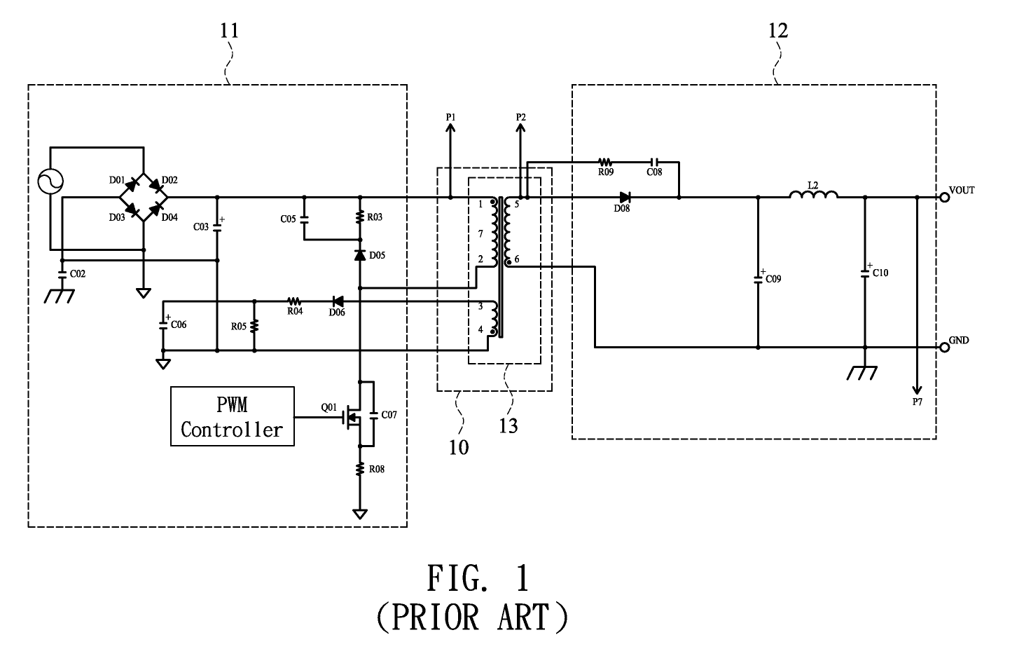

### DETAILED DESCRIPTION OF THE PREFERRED EMBODIMENTS

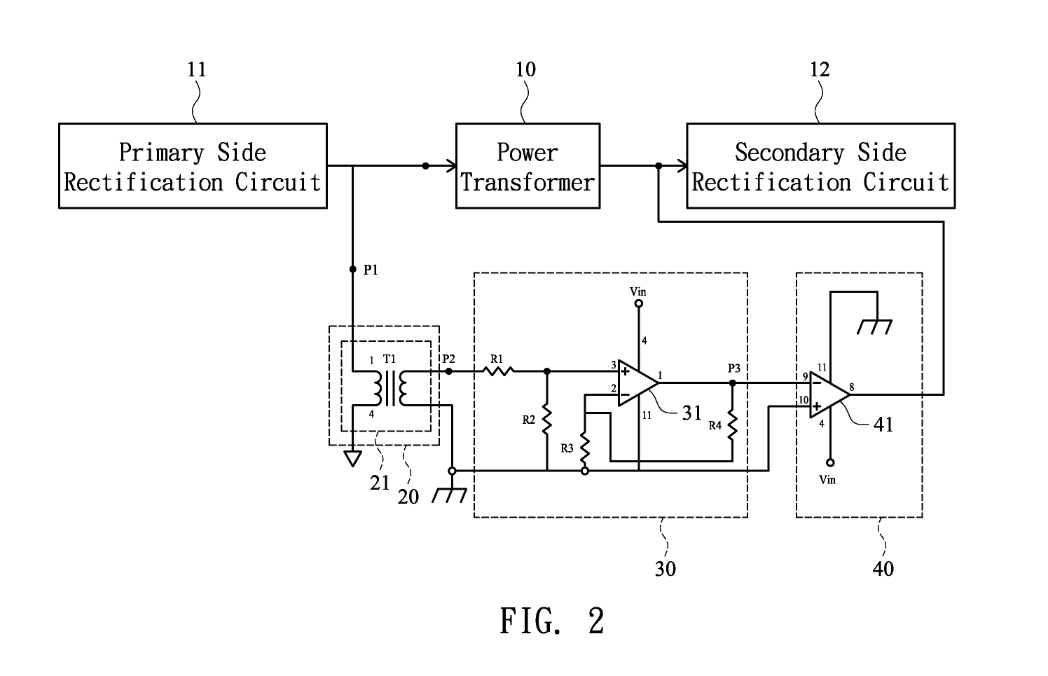

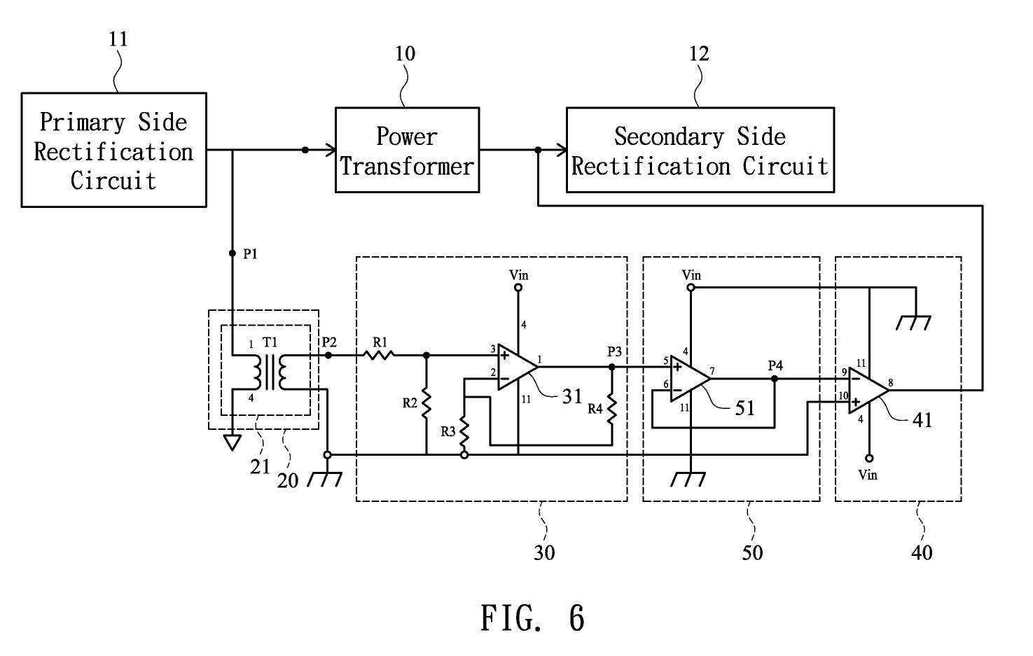

Referring to FIG. 2 and FIG. 6, embodiments of the present invention provide a regular circuitry for reducing ripple resulting from a line voltage transmitting to a secondary side of a power transformer. The regular circuitry includes: a ripple sampling circuit 20, a proportional amplifier circuit 30, and a reversing amplifier circuit 40. Therein, the regular circuitry is electrically connected in parallel with the power transformer 10, while the power transformer 10 is electrically connected in series between a primary side rectification circuit 11 and a secondary side rectification circuit 12.

As can be seen in FIG. 2, the ripple sampling circuit 20 has an input port electrically connected with an input port of the power transformer 10, and the ripple sampling circuit 20 includes a sampling transforming unit 21.

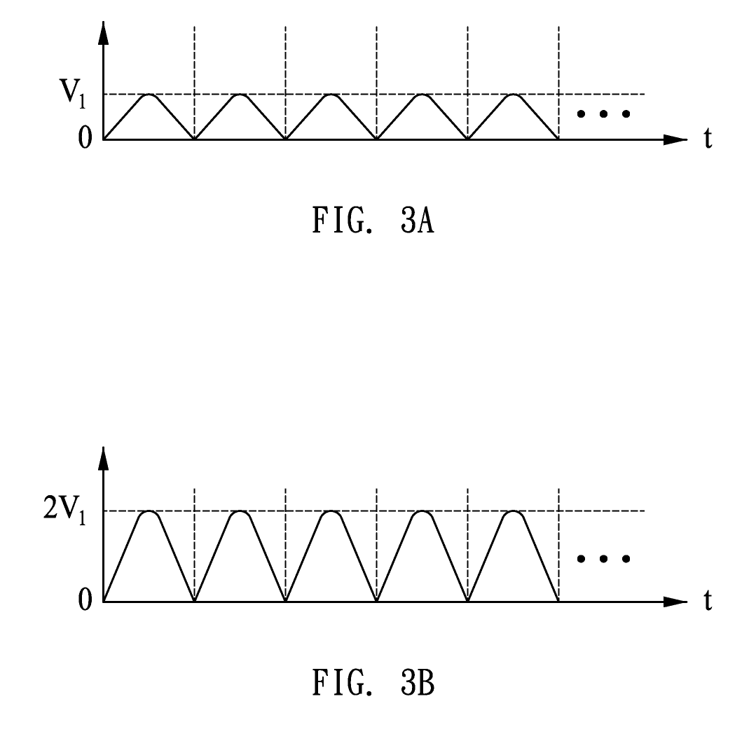

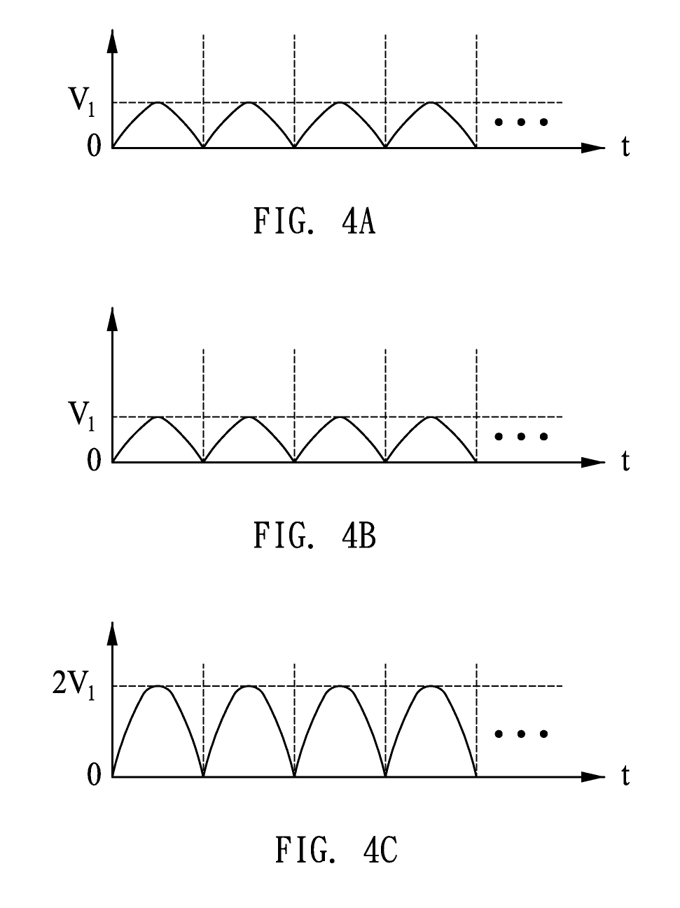

The sampling transforming unit 21 has one end (i.e. a first node P1) of its primary side electrically connected with the input port of the power transformer 10 and has one end of its secondary side electrically connected with the ground. Another end of the secondary side of the sampling transforming unit 21 is referred to as a second node P2. Since the input ports of the sampling transforming unit 21 and the power transformer 10 are electrically connected with each other, a line voltage signal input to the power transformer 10 is also input to the sampling transforming unit 21 (as shown in FIG. 3A). Therefore, the signal input to the primary side of the sampling transforming unit 21 is as shown in FIG. 4A.

When the turns ratio of the transforming unit in the power transformer 10 is 1:2, the output at the secondary side of the power transformer 10 has a waveform as shown in FIG. 3B. With the turns ration of the sampling transforming unit 21 at 1:1, the signal input to the power transformer 10 can be passed to the secondary side of the sampling transforming unit 21 with the resulting output equivalent to the input, thus making the output of the ripple sampling circuit 20 a sampling ripple (as shown in FIG. 4B). This sampling ripple is thus equal to the signal input to the power transformer 10. Alternatively, the turns ratio of the sampling transforming unit 21 may be set differently to generate differently scaled sampling ripples.

As shown in FIG. 2, the proportional amplifier circuit 30 may be composed of a differential amplifier 31, a first resistor R1, a second resistor R2, a third resistor R3 and a fourth resistor R4. The first resistor R1 has one end electrically connected with the end (i.e. the second node P2) of the output port of the secondary side of the sampling transforming unit 21 in the ripple sampling circuit 20. The second resistor R2 has one end electrically connected with another end of the first resistor R1. The second resistor R2 has another end electrically connected with the ground and the other end of the output port of the secondary side of the ripple sampling circuit 20. To clarify, the first resistor R1 and second resistor R2 that are electrically connected in series with each other are further electrically connected in parallel with the output port of the secondary side of the sampling transforming unit 21.

The differential amplifier 31 includes a first non-inverting input port, a first inverting input port, and a first output port (i.e. a third node P3). Therein, the first non-inverting input port is electrically connected with a node between the first resistor R1 and the second resistor R2. The third resistor R3 has one end electrically connected with the first inverting input port and another end electrically connected with the ground. The fourth resistor R4 has one end electrically connected with the first output port and another end electrically connected with the first inverting input port.

By altering the values of the resistance of the first resistor R1, the second resistor R2, the third resistor R3, and the fourth resistor R4, the proportional amplifier circuit 30 is made to perform corresponding proportional amplification. Therefore, after the proportional amplifier circuit 30 receives the sampling ripple from the ripple sampling circuit 20, the sampling ripple is amplified by the proportional amplifier circuit 30 to become an amplified sampling ripple (as shown in FIG. 4C), and is then output through the third node P3.

Referring to FIG. 2, the reversing amplifier circuit 40 is constructed from an inverting amplifier 41 with a third non-inverting input port, a third inverting input port, and a third output port. Therein, the third inverting input port is electrically connected with the first output port (i.e. the third node P3) of the proportional amplifier circuit 30 for receiving the amplified sampling ripple. The third non-inverting input port of the reversing amplifier circuit 40 is electrically connected with the ground. Through the reversing amplifier circuit 40, a reversed sampling ripple, which is reverse to the amplified sampling ripple in phase, is generated and output to an input port of the secondary side rectification circuit 12.

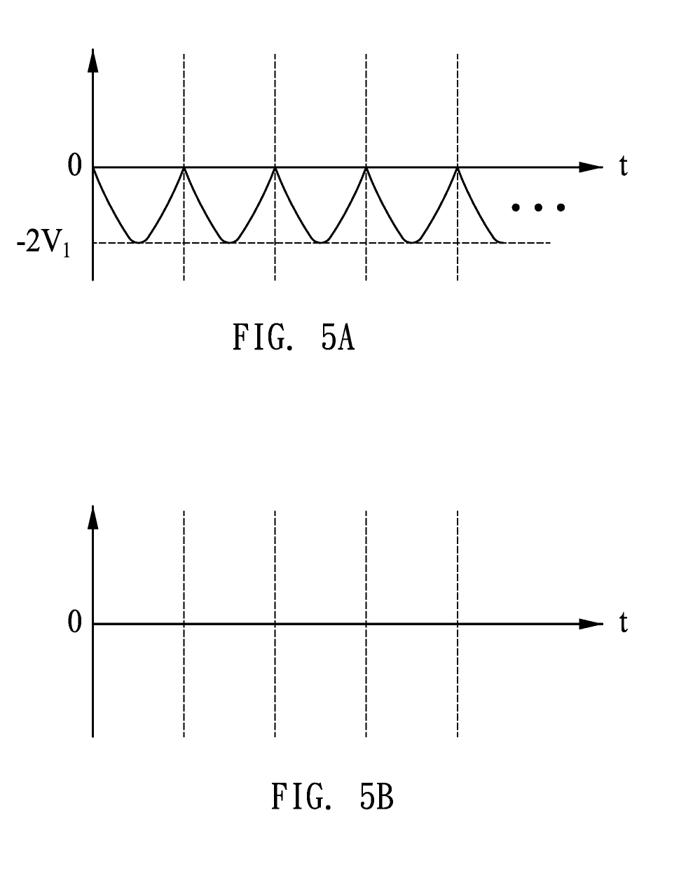

In FIG. 5A, a waveform of the amplified sampling ripple after being processed by the reversing amplifier circuit 40 is shown. Since the third output port of the reversing amplifier circuit 40 is electrically connected with the output port of the power transformer 10, the signal processed by the reversing amplifier circuit 40 and the signal output by the power transformer 10 superimpose each other so as to reduce the ripple output from the power transformer 10 (as shown in FIG. 5B), which is then input to the secondary side rectification circuit 12. Ideally, the ripple output by the power transformer 10 can be completely eliminated. However, in practical operation, since the signal generated by the reversing amplifier circuit 40 may be somehow different from the signal output by the power transformer 10 in phase or in waveform, this can only reduce the ripple at the secondary side of the power transformer 10 to a meaningful extent.

Referring to FIG. 6, for further reducing the ripple output by the power transformer 10, a buffer amplifier circuit 50 may be electrically connected in series between the proportional amplifier circuit 30 and the reversing amplifier circuit 40. The buffer amplifier circuit 50 receives the amplified sampling ripple output by the proportional amplifier circuit 30 and increases the input impedance thereof to form an ideal power source. Therein, the buffer amplifier circuit 50 is constructed from an operational amplifier 51. The operational amplifier 51 has a second non-inverting input port, a second inverting input port, and a second output port. The second non-inverting input port is electrically connected with the first output port (i.e. the third node P3) of the proportional amplifier circuit 30, while the second output port (i.e. the fourth node P4) is electrically connected with the second inverting input port.

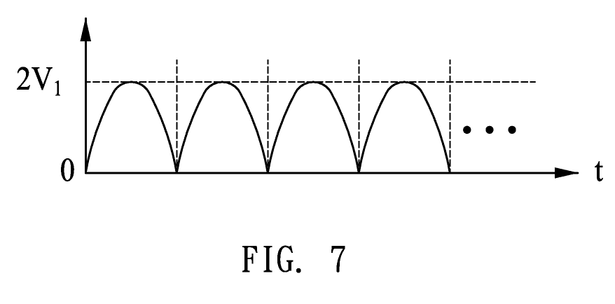

The buffer amplifier circuit 50 serves to increase input impedance, so as to maintain the waveform of the amplified sampling ripple, which is processed by the buffer amplifier circuit 50, in a desired shape (as shown in FIG. 7). The reversing amplifier circuit 40 receives the amplified sampling ripple processed by the buffer amplifier circuit 50. For example, the amplified sampling ripple processed by the buffer amplifier circuit 50 may be output by the second output port (i.e. the fourth node P4) to the third inverting input port of the reversing amplifier circuit 40.

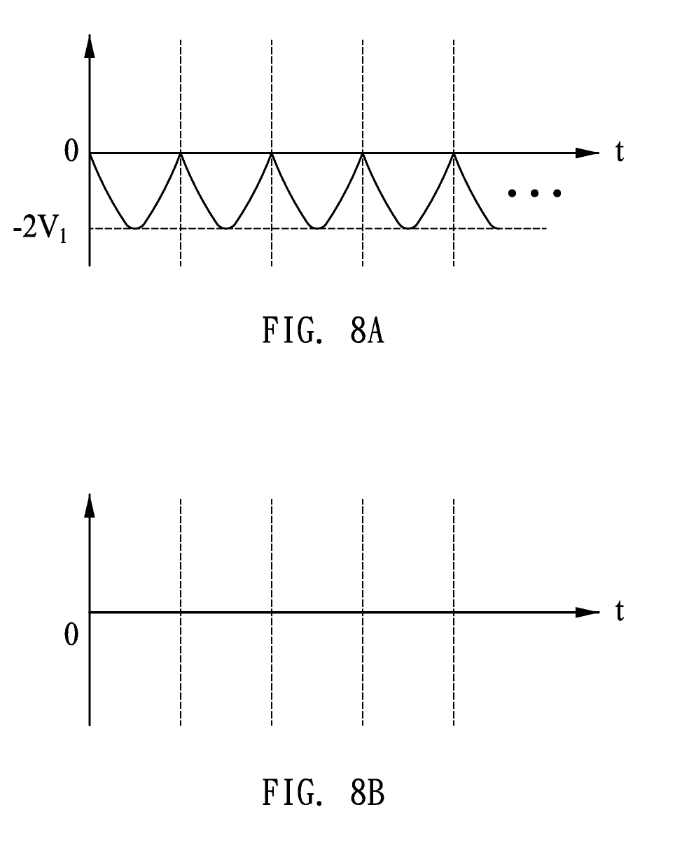

FIG. 8A is the waveform of the signal processed by the reversing amplifier circuit 40. This signal superimposes on the signal output by the power transformer 10 to eliminate the ripple output by the power transformer 10 with the improved effect. FIG. 8B shows the waveform of the signal in which the ripple has been completely eliminated, as an ideal effect.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A regular circuitry for reducing ripple resulting from a line voltage transmitting to a secondary side of a power transformer, the regular circuitry being electrically connected in parallel with the power transformer, and the power transformer being electrically connected in series between a primary side rectification circuit and a secondary side rectification circuit, the regular circuitry comprising:
a ripple sampling circuit, having an input port electrically connected with an input port of the power transformer and an output port outputting a sampling ripple;
a proportional amplifier circuit receiving the sampling ripple and amplifying the sampling ripple to generate an amplified sampling ripple; and
a reversing amplifier circuit receiving the amplified sampling ripple and inversely outputting the amplified sampling ripple to an input port of the secondary side rectification circuit, so as to reduce the ripple output by the power transformer.

2. The regular circuitry of claim 1, wherein the ripple sampling circuit has a sampling transforming unit, which has a primary side electrically connected with the input port of the power transformer and has a secondary side with one end electrically connected with the ground.

3. The regular circuitry of claim 1, wherein the proportional amplifier circuit comprises:
a first resistor having one end electrically connected with one end of the output port of the ripple sampling circuit;
a second resistor having one end electrically connected with another end of the first resistor and another end electrically connected with the other end of the output port of the ripple sampling circuit and a ground;
a differential amplifier having a first non-inverting input port, a first inverting input port, and a first output port, wherein the first non-inverting input is electrically connected with a node between the first resistor and the second resistor;
a third resistor having one end electrically connected with the first inverting input port, and another end electrically connected with the ground; and
a fourth resistor having one end electrically connected with the first output port and another end electrically connected with the first inverting input port.

4. The regular circuitry of claim 1, further comprising a buffer amplifier circuit, which receives the amplified sampling ripple output by the proportional amplifier circuit and increases input impedance of the amplified sampling ripple to form an ideal power source.

5. The regular circuitry of claim 4, wherein the buffer amplifier circuit comprises an operational amplifier, which has a second non-inverting input port, a second inverting input port, and a second output port; and the second non-inverting input port is electrically connected with a first output port of the proportional amplifier circuit, and the second output port is electrically connected with the second inverting input port.

6. The regular circuitry of claim 4, wherein the reversing amplifier circuit receives the amplified sampling ripple output by the buffer amplifier circuit.

7. The regular circuitry of claim 4, wherein the reversing amplifier circuit comprises: an inverting amplifier, which has a third non-inverting input port, a third inverting input port, and a third output port; and the third inverting input port is electrically connected with the second output port, the third non-inverting input port is electrically connected with a ground, and the third output port is electrically connected with an output port of the power transformer.

8. The regular circuitry of claim 1, wherein the reversing amplifier circuit comprises an inverting amplifier, which has a third non-inverting input port, a third inverting input port, and a third output port, and the third inverting input port is electrically connected with a first output port of the proportional amplifier circuit, the third non-inverting input port is electrically connected with a ground, and the third output port is electrically connected with an output port of the power transformer.
